(19) United States
(12) Patent Application Publication
(10) Pub. No.: US 2015/0136680 A1
(43) Pub. Date: May 21, 2015

(54) Internal Pod for Gauze Filter of Water Filter

(71) Applicant: General Filter Benleumi LTD, Tveria (IL)

(72) Inventors: Erez Mazor, Tveria (IL); Ronen Aharon Cohen, Moza Elit (IL)

(73) Assignee: GENERAL FILTER BENLEUMI LTD, Tveria (IL)

(21) Appl. No.: 14/543,916

(22) Filed: Nov. 18, 2014

(30) Foreign Application Priority Data
Nov. 19, 2013 (IL) 229494

(51) Int. Cl. B01D 24/10; B01D 29/56

(52) U.S. Cl. CPC B01D 24/10; B01D 29/56
USPC 210/289; 210/337

(57) ABSTRACT

An internal pod designed to be incorporated into a gauze filter in a filter housing consisting of a container and a cover. The container consists of a closed circumferential conical wall, a bottom with lower holes, and a cover with upper holes. Wherein water treatment material or another filter can be incorporated into the inner pod, and wherein the water flows through the layer of material or the other filter and out through the holes in the bottom of the inner pod, continuing through the walls of the gauze filter to the outlet opening of the filter housing.

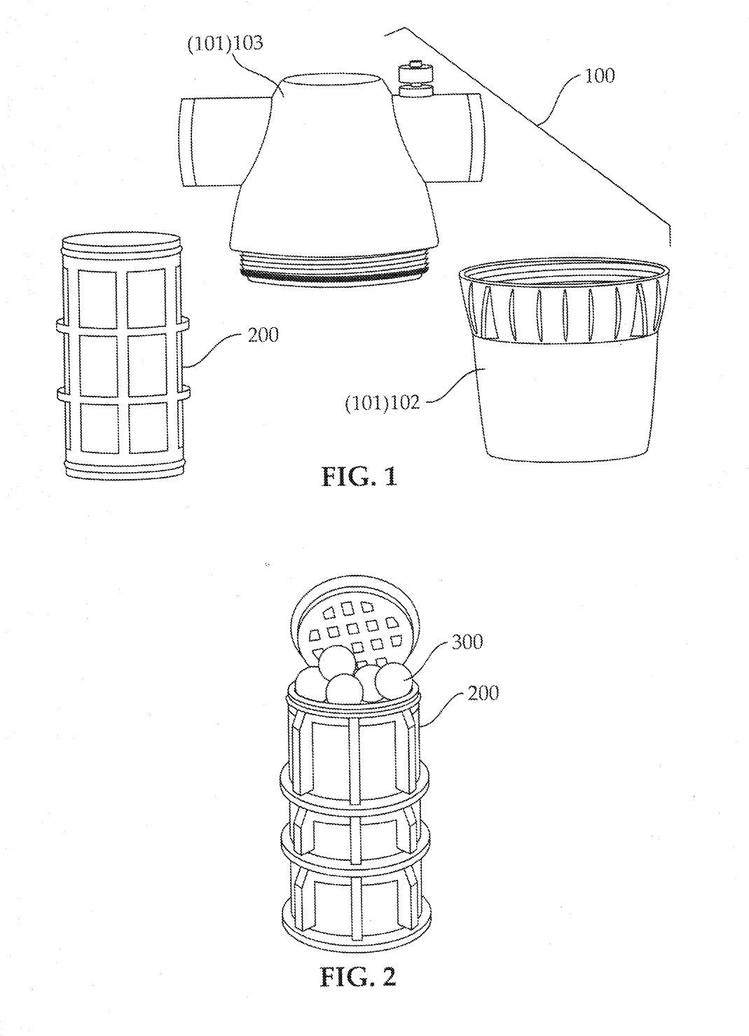

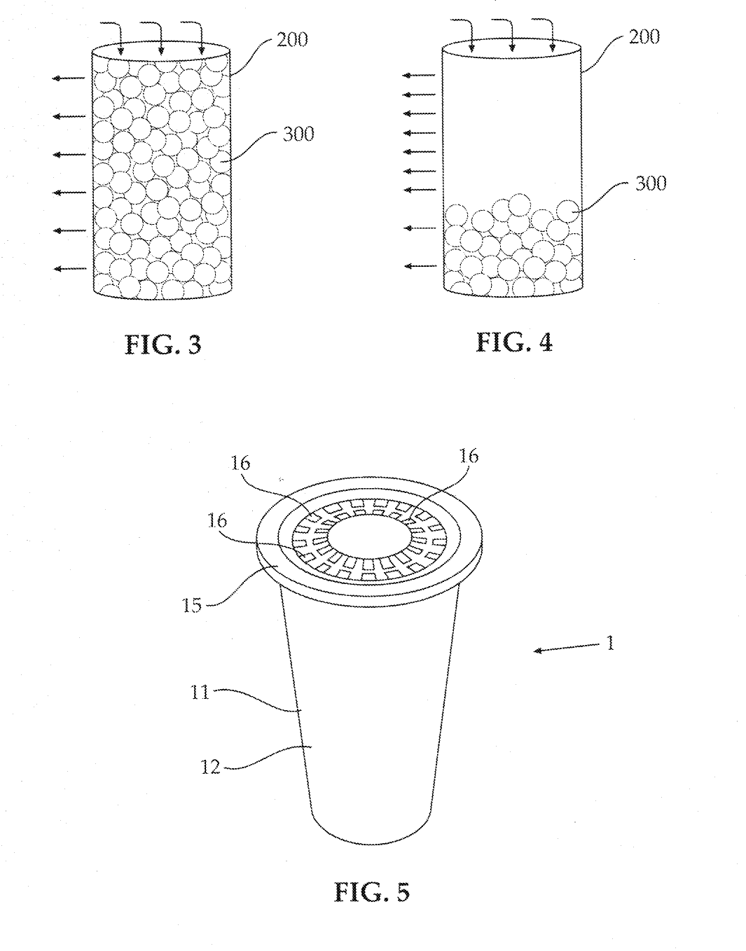

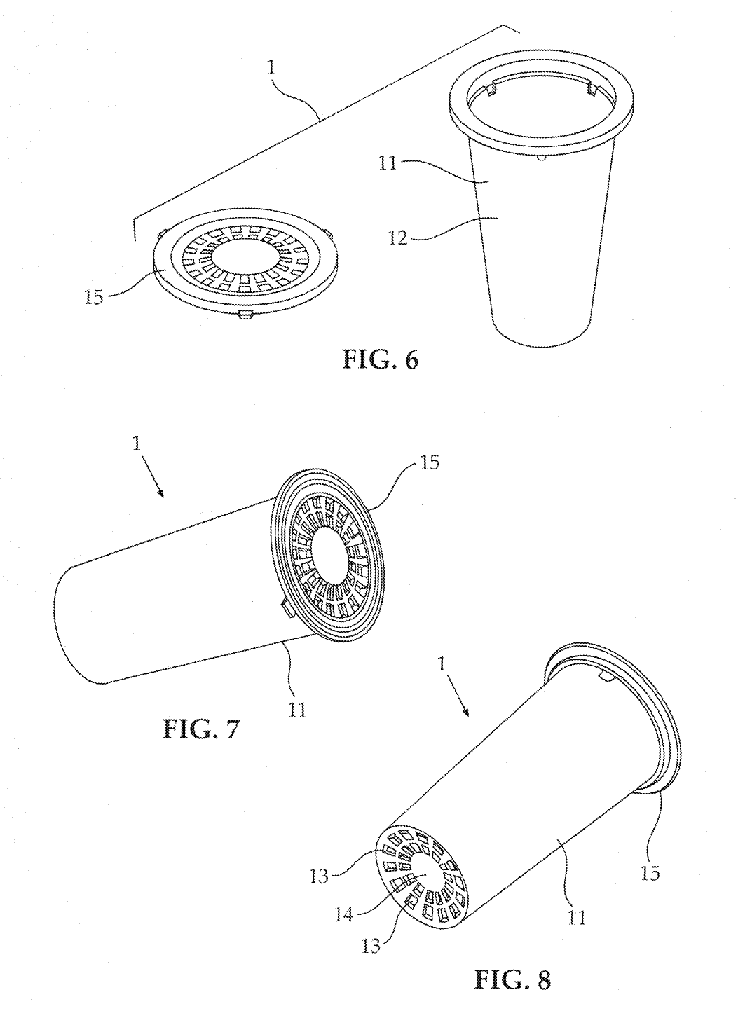

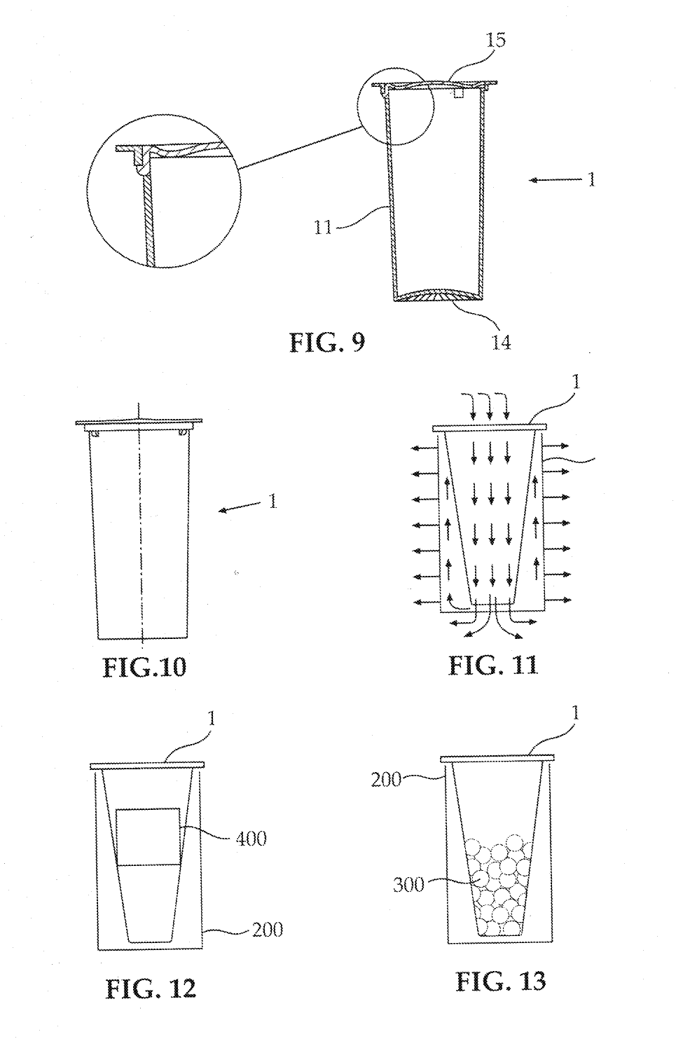

### TECHNICAL FIELD

The present invention refers to the internal pod of the gauze filter of a water filter.

### BACKGROUND ART

The use of water filters to purify and treat water, including water intended for drinking, is Very common and well known. In many places it is customary to install a water filter on the main inlet pipe of a building. A very commonly used standard water filter (100) consists of a filter housing (101), which includes a base (102) and a cover (103) joined together by a threaded connection, into which a gauze filter (200) is often inserted. The water flows into the filter housing (101), passing through the inner part of the gauze filter (200), and flowing out through its circumferential sides, continuing towards the outlet opening from the filter housing (101) to the pipe that leads to the building. All the aforementioned is common knowledge to professionals in this area. Drawing No. 1 depicts a water filter (100), which includes a disassembled filter housing (101) and the gauze filter (200).

In addition to using a gauze filter (200) to filter water, it is common to integrate water treatment materials (hereinafter “water treatment materials”) (300), such as siliphos crystals, into water filters (100). The siliphos dissolved in the water prevents scale-forming minerals from settling on pipes and household appliances despite the water being heated or standing still. Siliphos crystals are usually spherical; they prevent the formation of scale; thus protecting piping and water-based home appliances. Furthermore, it is customary to integrate other types of filters such as carbon filters, ceramic filters, and so on (hereinafter “other filters”) (400) into water filters (100). Carbon filters consist of a compartment containing active carbon designed to filter and remove organic substances from the water as well as any substances that cause undesirable flavors and odors. Ceramic nanofilters consist of a compartment containing ceramic balls made from Al₂O₃, SiO₂, TiO₂ and so on, and are suitable and designed to remove microorganisms, toxic minerals, and bacteria from the water.

Drawing No. 2 depicts an example of the manner in which water treatment materials (300) are commonly incorporated; this case includes a description of siliphos balls (300) within a gauze filter (200) and Drawings Nos. 3 and 4 schematically depict the water flow path. At the outset, when the gauze filter (200) is full of siliphos balls (300), as depicted for example in Drawing No. 3, the water flows in through the upper opening of the gauze filter (200), dissolves the siliphos halls (300) in the upper part of the gauze filter and then flows out through the walls of the gauze filter (200). However, after some of the siliphos balls have dissolved in the water and only the lower part of the gauze filter is still full of siliphos balls, as depicted for example in Drawing No. 4, the water flows out through the upper part of the gauze filter walls, and does not flow effectively and in adequate quantity through the siliphos balls at the bottom of the gauze filter. As a result, the siliphos balls in the water filter do not perform their function effectively, whereas the user believes that as long as the filter housing contains siliphos balls, the water is being treated effectively. It is clear that this problem occurs whenever water treatment materials (not only siliphos) are incorporated into the gauze filter.

In cases in which we wish to incorporate a gauze filter together with another filter (400) into the water filter, we must first remove the standard gauze filter and use a filtration core that includes an integral gauze filter combined with another filter. This causes waste, since the gauze filter must be disposed of along with the other filter whenever the active material in the other filter has completely dissolved as they are made of one integral piece.

The present invention is intended to provide an effective solution to the aforementioned problems by describing an internal pod designed to be incorporated into the standard gauze filter, in a manner that enables to fill the internal pod with water treatment materials, such as siphilos, or to install other filters in it such as carbon filters, ceramic filters, nanofilters, and so on.

### LIST OF DRAWINGS

The intention of the drawings attached to the application is not to limit the scope of the invention and its application. The drawings are intended only to illustrate the invention and they constitute only one of its many possible implementations.

Drawing No. 1 depicts a standard water filter (100) which consists of a filter housing (101) and a gauze filter (200).

Drawing No. 2 depicts a gauze filter (200) containing water treatment material (300).

Drawing No. 3 depicts a gauze filter (200) filled with water treatment material (300), with arrows indicating the water flow path.

Drawing No. 4 depicts a gauze filter (200) partially filled with water treatment material (300), with arrows indicating the water flow path.

Drawings Nos. 5, 7, and 8 depict the inner pod (1) which includes a container (11) and a cover (15).

Drawing No. 6 depicts a disassembled inner pod (1) which consists of a container (11) and a cover (15).

Drawings Nos. 9 and 10 presents a cross section of the inner pod (1) which includes a container (11) and a cover (15).

Drawing No. 11 depicts the inner pod (1) integrated within a standard gauze filter (200), with arrows indicating the water flow path.

Drawing No. 12 depicts the inner pod (1) integrated within a standard gauze filter (200) into which another filter is integrated (400).

Drawing No. 13 depicts the inner pod (1) integrated within a standard gauze filter (200) containing water treatment material (300).

### THE INVENTION

The main purpose of the present invention is to provide an inner pod designed to be integrated into a standard gauze filter, in a manner that enables to fill the inner pod with water treatment material or to integrate another filter within it so that water flows through the entire layer of water treatment material or through all other filters in the inner pod, and only alter the water exits the bottom of the inner pod does it flow through the gauze filter walls to the outlet opening of the filter housing.

The inner pod (1), which is depicted in isometric view in Drawings Nos. 5, 7 and 8, consists of a container (11) with a closed circumferential conical wall (12), a bottom (14) with lower holes (13), and a cover (15) with upper holes (16). Drawing No. 6 depicts the container (11) alongside its cover (15). Drawings Nos. 9 and 10 present a side cross section of the pod (1).

Drawing No. 11 presents a schematic cross section of the manner in which the inner pod (1) is incorporated into a standard gauze filter (200), including arrows indicating the direction of water flow. Drawing No. 12 presents a schematic. cross section of the manner in which the inner pod (1) is incorporated into a standard gauze filter (200) into which another filer (400) is incorporated, while Drawing No. 13 depicts the same situation. in which the gauze filter (200) contains water treatment material (300). The water flows first into the inner pod (1) through the upper holes (16) in the cover (15), passing through the water treatment materials (300) and other filters (400) which may be incorporated into the inner pod (1), The water then flows out through the lower holes (1) at the bottom (14) of the container (11) and passes through the walls of the gauze filter (200) towards the outlet opening in the filter housing (100).

Using the inner pod (1) enables the user to incorporate water treatment materials (300) and/or other filters (400) into it so that water flows in adequate quantity and effectively through said materials (300) and filters (400). Only then is the water treated by passing through the gauze filter (200) and flowing from there outward through the outlet opening in the filter housing (100), In addition, the inner pod (1) enables users, suppliers and manufacturers to incorporate various materials (300) and filters (400) within it, as needed, and enables occasional replacement of said materials and other filters from time to time, as needed.

The fact that the inner pod (1) is cone-shaped enables the water to flow efficiently into the space between the external wall of the inner pod (1) and the inner wall of the gauze filter (200) and from there through the walls of the gauze filter (200) to the outlet opening of the water filter (100).

What is claimed is:

1. An internal pod designed to be incorporated into a gauze filter which is incorporated into a filter housing consisting of a container and a cover; wherein the container consists of a closed circumferential conical wall and a bottom with lower holes; wherein the cover has upper holes; wherein water treatment material or another filter can be incorporated into the inner pod, and wherein the water flows through said layer of material or other filter and out through the lower holes in the bottom of the container, continuing through the walls of the gauze filter to the outlet opening of the filter housing.
